(19) United States
(12) Patent Application Publication
(10) Pub. No.: US 2003/0028871 A1
(43) Pub. Date: Feb. 6, 2003

(54) Behavior profile system and method

(76) Inventors: Annie Wang, San Jose, CA (US); Richter A. Rafey, Santa Clara, CA (US); Ravi Gauba, Fremont, CA (US); Klaus Hofrichter, Santa Clara, CA (US); Clement Lau, Los Altos, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/909,575

(22) Filed: Jul. 20, 2001

(51) Int. Cl. H04N 7/16; H04H 9/00

(52) U.S. Cl. 725/9

(57) ABSTRACT

A method of generating personalized television programming content. The method involves developing a user profile and employing a filtering process to isolate relevant content to be presented. The filtering process involves the removal of content that does not fit the customization profiles of any of the system users usage patterns. The method further involves marking content suitable for a particular user and presenting the marked content to the user.

### FIELD OF THE INVENTION

The invention relates generally to the provision of personalized service into the home broadcast environment.

### BACKGROUND OF THE INVENTION

Currently, personalization is playing an important role in bringing desirable programming content into the home broadcast environment. Personalization is typically generated in two ways: it is either explicitly instructed by a user through a user interface or it is implicitly learned by monitoring the user's usage patterns and applying logic to predict the user's preference. Explicit personalization is generally straightforward and does not require any interpretation. But implicit personalization requires some form of analysis and logic to interpret and make judgments based on a user's preferences.

Where there are multiple users sharing the system, implicit personalization must take into account that there are different modes of user viewing. The system should have the capacity to make distinctions amongst the differing usage patterns detected so that appropriate assumptions about the system's users may be made. If the techniques used to implement personalization are inadequate, it can be very frustrating for system users.

### SUMMARY OF THE INVENTION

A method of generating personalized broadcast programming content comprising developing a user profile and employing a filtering process to isolate relevant content to be presented.

### BRIEF DESCRIPTION OF THE DRAWINGS

The present invention is illustrated by way of example and not intended to be limited by the figures of the accompanying drawings in which like references indicate similar elements and in which:

FIG. 1 shows one embodiment of the system architecture of the present invention.

FIG. 2 shows exemplary functionalities of one embodiment of the cartridges utilized in one embodiment of the present invention.

FIG. 3 depicts an exemplary processing system in accordance with one embodiment of the present invention.

FIGS. 4a and 4b illustrate embodiments of processes for creating and/or modifying user profiles in accordance with the teachings of the present invention.

FIGS. 5a and 5b show embodiments of a two level filtering process in accordance with the present invention.

FIG. 6 shows one embodiment of a process used to manage customization settings.

FIG. 7 is an example of using removable media to transfer user profiles in accordance with one embodiment of the invention.

### DETAILED DESCRIPTION

In the following description, for purposes of explanation, numerous details are set forth in order to provide a thorough understanding of the present invention. However, it will be apparent to one skilled in the art that these specific details are not required in order to practice the present invention. In other instances, well known electrical structures and circuits are shown in block diagram form in order not to obscure the present invention unnecessarily.

The system and method of the present invention provides for personalizing user content using implicitly generated profiles. A user's pattern of behavior is monitored and based upon a frequency of similar patterns monitored the user type is identified. In one embodiment in which the content is program content (e.g., television, cable programming), one type of user is a content surfer who switches frequently among different programs. Another type of user is a longtime watcher who watches a program for long periods of time. Implicit generation of a user profile or modification of an existing profile is then based the user's viewing behavior and the type of user.

The present invention in some embodiments, further implements a two-level filtering process to address storage management and presentation management issues of content. In one embodiment in which the content is program content, metadata which describes the content and user profiles are utilized. In one embodiment the filtering process consists of two levels or phases. The first phase removes any content from the storage area that does not fit the customization profile of one or more users of the system. The second phase selects content suitable for presentation for a specific user.

Also disclosed is a system which can use removable media to store profile information. This would allow the user to set his preferences once, remove the media, and transfer the preferences in a profile to a compatible system.

Other features and advantages of the present invention will be apparent from the accompanying drawings and from the detailed description that follows below.

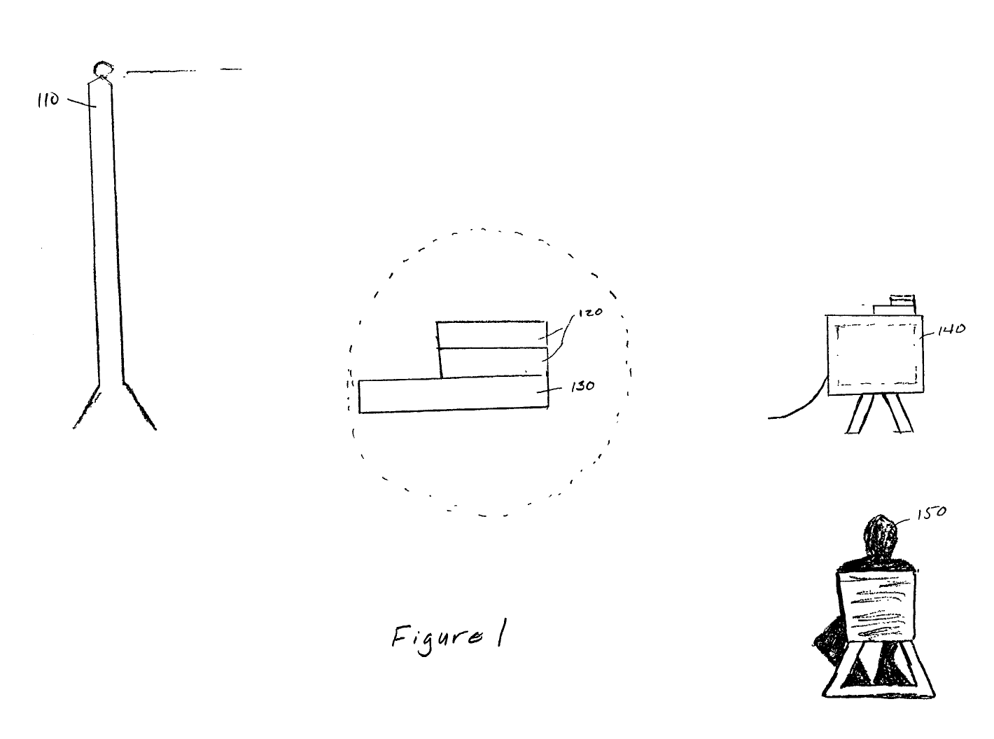

FIG. 1 shows one embodiment of the system architecture of the present invention. FIG. 1 shows service provider 110, base station 130, cartridges 120, television monitor 140 and home viewer 150.

The service provider 110 transmits services into the home environment. In one embodiment, the transmissions from the service provider 110 to the same home environment include both programming content and metadata. Alternately, the metadata may be provided through a separate temporal transmission, contemporaneously or noncontemporaneously, or different media, for example, the Internet. The metadata describes the programming content. These transmissions may be made by conventional means (broadband, broadcast, Internet etc.). In one embodiment the service provider 110 includes the functionality of profile development and content management. In one embodiment, the service provider further maintains profiles.

In one embodiment a storage medium contains the profiles described herein. In one embodiment, the storage is located in one or more cartridges 120 which, in one embodiment, further possess profile developing and content managing functionalities. These functionalities enable the cartridges to develop profiles for the various users present in the home environment. Using the cartridges, programming content may be cached based on the developed profiles. In one embodiment having multiple cartridges, each cartridge is service provider specific, and has its own tuner, thereby permitting concurrent recording of different channels.

Base station 130 includes a processor that functions, in one embodiment, to facilitate the execution of the various user customization processes including the profile generation, modification and content filtering processes described herein. In alternate embodiments, the profile generation, modification and/or filtering processes as well as the storage of content may occur at the service provider 110. In another embodiment, the processes are performed on the base station 130. In addition, the base station 130 transmits the A\V (audiovisual) signal containing the generated personalized programming content to the television receiver 140 for viewing by home viewer 150.

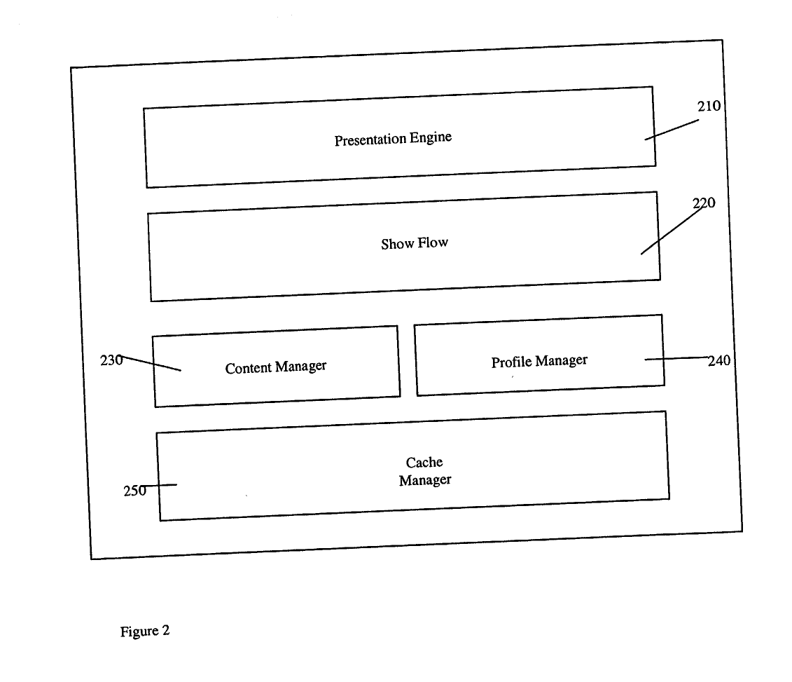

FIG. 2 shows exemplary functionalities of one embodiment of the cartridges of the present invention. FIG. 2 shows presentation mechanism 210, show-flow mechanism 220, content manager 230, profile manager 240 and cache manager 250.

The cache manager 250 receives transmitted signals composed of content, information and metadata. The cache manager collects the data to be processed and eventually presented in some form to the viewer.

Profile manager 240 manages profile development. In one embodiment, profiles are developed for each home user. These profiles are used to determine the program that is eventually presented. In one embodiment, two types of profiles are used. A behavior profile records user activity and is used to evaluate user activity based upon the type of user. A user preference file contains the user preferences used to perform the filtering processes described herein. In one embodiment in which two separate profiles are generated, the behavior profile is used to update, selectively or automatically, the user preference profile. In alternate embodiments, the behavior profile and user preference profile may be combined into one profile.

Content manager 230 manages the content of the programming that is eventually presented. The content manager uses the user preference profiles to filter the programming content. In one embodiment, the content filtering process is enabled by the metadata transmissions provided by the service provider which describe the content of the program. The metadata may be transmitted with or separate from the content.

Show-flow mechanism 220 facilitates the flow of data to the presentation mechanism. The show-flow mechanism interacts with both the profile manager and the content manager. When a particular user is detected, the show-flow mechanism elicits the preference profile for the user from the profile manager. Also, for a particular user, the show-flow mechanism elicits a content list from the content manager. The show-flow mechanism takes the information provided by the profile manager and the content manager and generates a personalized programming content list.

Presentation mechanism 210 provides a browser layout that is presented to the user to assist with programming selection and other user control functions discussed herein.

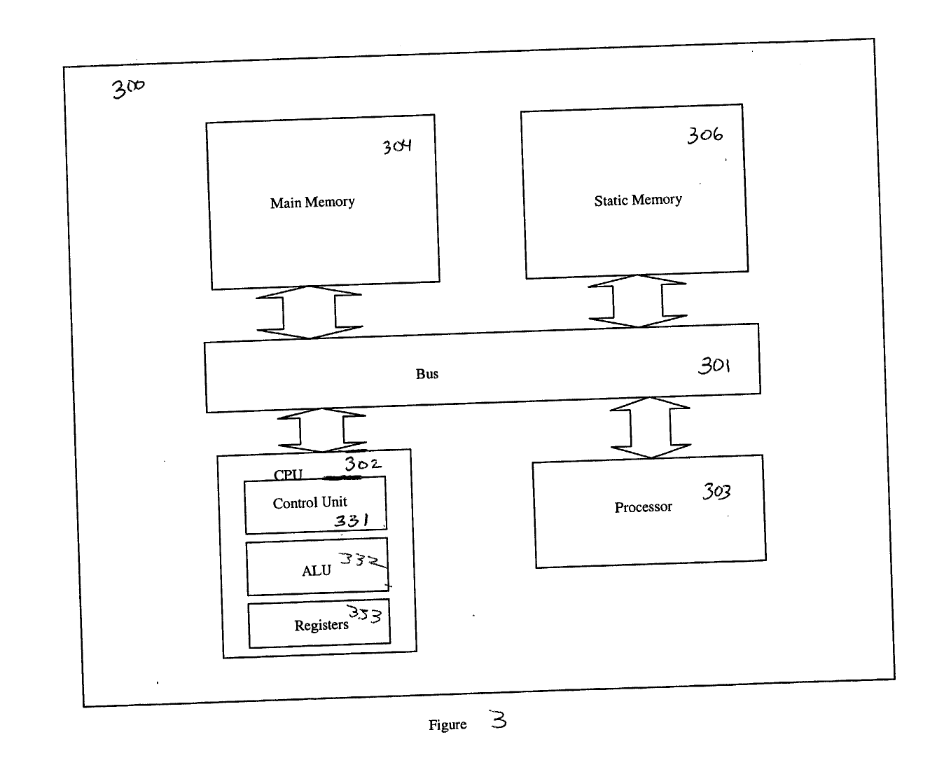

FIG. 3 depicts an exemplary processing system 300 in which the present invention may be implemented. This processing system may be implemented at the service provider, or in the content receiver environment (e.g., the office or home), for example, in a set top box, personal computer and the like. In one embodiment, the processes described herein may be implemented and executed using a general processing architecture. Referring to FIG. 3, the processing system may include a bus 301 or other communication means for communicating information, and a central processing unit (CPU) 302 coupled to the bus for processing information. CPU 302 includes a control unit 331, an arithmetic logic unit (ALU) 332 and registers 333. CPU 302 can be used to implement the processes and functions described herein. Furthermore, another processor 303 such as, for example a coprocessor, may be coupled to the bus 301 for additional processing power and speed.

The processing system 300 also includes a main memory 304, which may be a random access memory (RAM) device, that is coupled to the bus 301. The main memory stores information and instructions to be executed by CPU 302. Main memory 304 may also store temporary variables and other intermediate information during the execution of instructions by CPU 302. The processing system also includes a static memory 306, for example a read only memory (ROM) and/or other static device, that is coupled to the bus for storing static information, including profile information, and instructions for CPU 302.

In addition, the methods as described above can be stored in memory of a computer system as a set of instructions to be executed. The instructions to perform the methods as described above could alternatively be stored on other forms of computer-readable mediums. For example, the method of the present invention can be stored on computer-readable mediums, such as magnetic disks or optical disks that are accessible via a disk drive (or computer-readable medium drive).

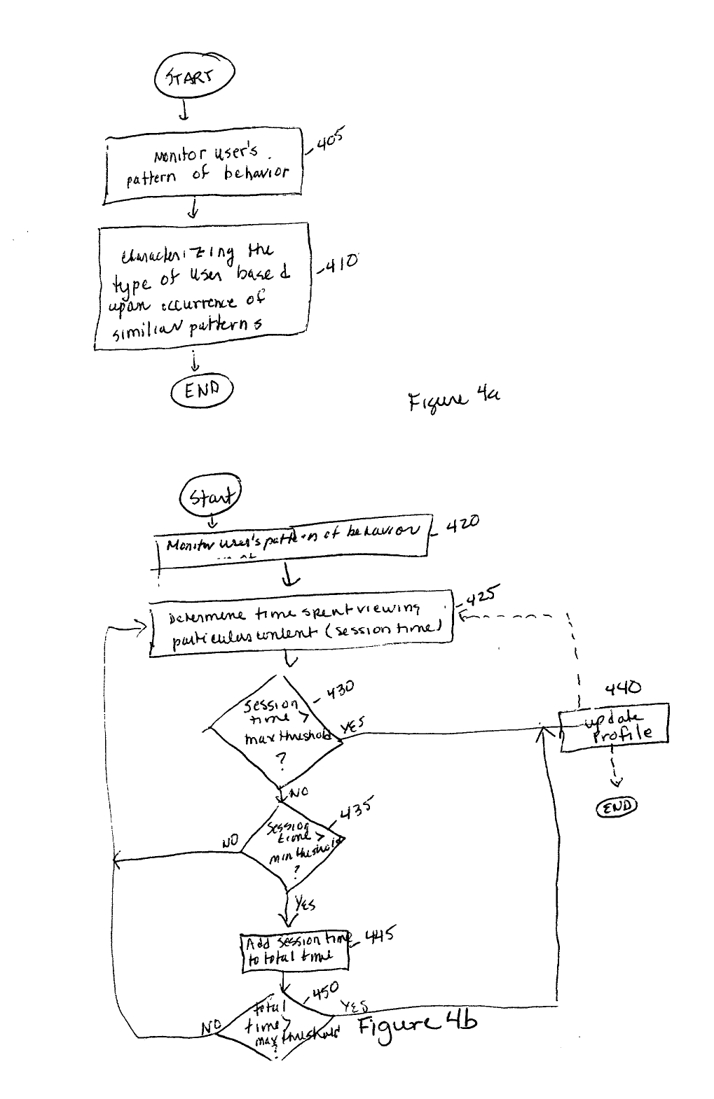

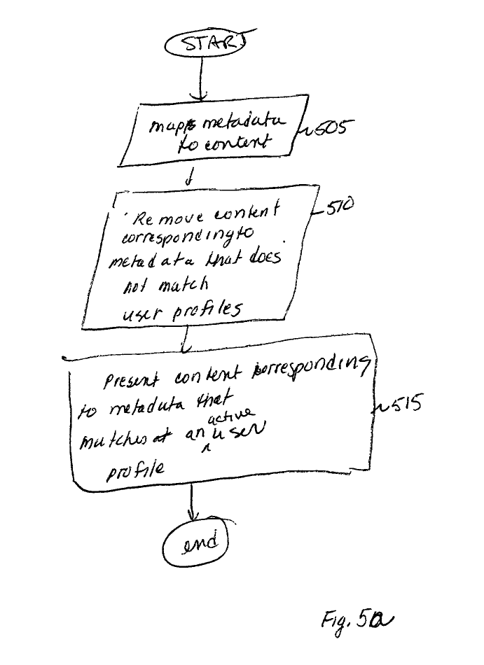

As noted earlier, user preference profiles, which typically include user preferences regarding operation of one or more devices including content received through a particular device, may be received through a particular device or may be created and modified a variety of ways. In one embodiment, the user profile is at least in part generated and/or modified implicitly in accordance with a “type” of user identified. This process is described with reference to FIG. 4a. At step 405, the user's pattern of behavior or usage of the device is monitored. At step 410, the type of user is characterized based upon the occurrence of similar behavior patterns. In one embodiment, the behavior may be viewing behavior. In other embodiments, the behavior may be access, recording or some other form of usage of content or a device.

In one embodiment, this process is used to generate user behavior profiles for viewing programming content, for example for viewing programs received over cable networks, satellite networks the Internet and the like. In one embodiment, the type of user is characterized based upon how frequently the user switches between channels or content sources. Thus, for example, when the user starts viewing a program and within minutes he switches to view what else is available, then switches back and stays viewing for a few minutes and switches again, a similar sequence of actions are repeated. In one embodiment, the system logs the user's viewing pattern to the user's behavior profile and when the system observes the same viewing pattern a predefined number of times, and alternately, a predefined number of times within a predetermined time frame, the system would classify this user as a content surfer, rather than a long-time watcher.

In one embodiment, continuing with the above example, in order to accommodate both a content surfer and a long-time watcher, the system tracks the content viewed and the time the user spends viewing the content. In one embodiment, a maximum threshold is set. The maximum threshold set is a time value indicative that the viewer has looked at the content long enough to indicate that he has an “interest” in the content and this should be noted in the user profile. For example, a maximum threshold may be set to 15 minutes. Two maximum thresholds may be set—one to accommodate content surfers and one to accommodate long-time watchers. However, as shown in the embodiment set forth in FIG. 4b the process for creating and/or updating behavior profiles may address both the content surfer and long-time watcher.

In the embodiment set forth in FIG. 4b, in addition to the maximum threshold, a minimum threshold is set. The minimum threshold is set to a value indicative of how long a content surfer would view a program of interest, for example two minutes, before switching to another channel. Referring to FIG. 4b, the user's pattern of behavior is monitored, step 420. At step 425, the time spent viewing particular content (session time), is determined. If the session time is greater than the maximum threshold, step 430, the behavior profile of the user is updated to reflect the users preference for the corresponding content viewed, step 440. If the session time is not greater than the maximum threshold, step 430, the session time is compared to the minimum threshold, step 435. If the session time is greater than the minimum threshold, the session time is added to a total time, step 445, and at step 450 if the total time is greater than the maximum threshold the preference profile is updated, step 440. In one embodiment, the total time is summed over a predetermined period which may be useful to indicate or determine a channel surfer's preference. For example, the sum is maintained for a maximum period of an hour before being reset to zero. Thus, the test at step 430 accounts for a long-time watcher while steps 435, 445 and 450 addresses a content surfer. Once the preference profile is updated, step 440, the process can continue at step 425. As noted earlier, in one embodiment the behavior profile and preference profile may be one profile or, in alternate embodiments, separate profiles. If separate profiles are used, the preference profile is updated with user preference information determined from the behavior profile.

As noted earlier, the user preferences may be used to control a device, for example, to control a set top box and program content to view or store for later viewing. One application is in conjunction with the use of multimedia services that rely on what is referred to as “push” technology. This is typically implemented with respect to digital television broadcast and broadband networks. Push technology is based on a service provider driven content delivery model, where a large number of customers receive the same content through a high speed data connection such as a satellite broadcast. The customers may have a storage medium to store the content for subsequent viewing. Although this mechanism relieves the service provider from delivering individually selected content portions to individual customers, this causes the storage of content that may not be of interest or desirable to a particular user.

In one embodiment, the user preferences and content metadata are utilized as part of a two level filtering process to decrease the amount of unwanted content. This process would typically be performed at the location of the receipt of the content although other embodiments, for example, remotely operative through network control, are also contemplated.

The metadata describes corresponding content and typically accompanies the delivery of the content, although it is contemplated that the delivery of the metadata may be through a separate media or network, separate from the delivery of the content. The format and the entries in fields of the metadata are typically tailored to the service provider and contain such content descriptive information as genre information for video clips (e.g., Sports, Weather, Politics), or keywords (e.g., soccer world championship 2000).

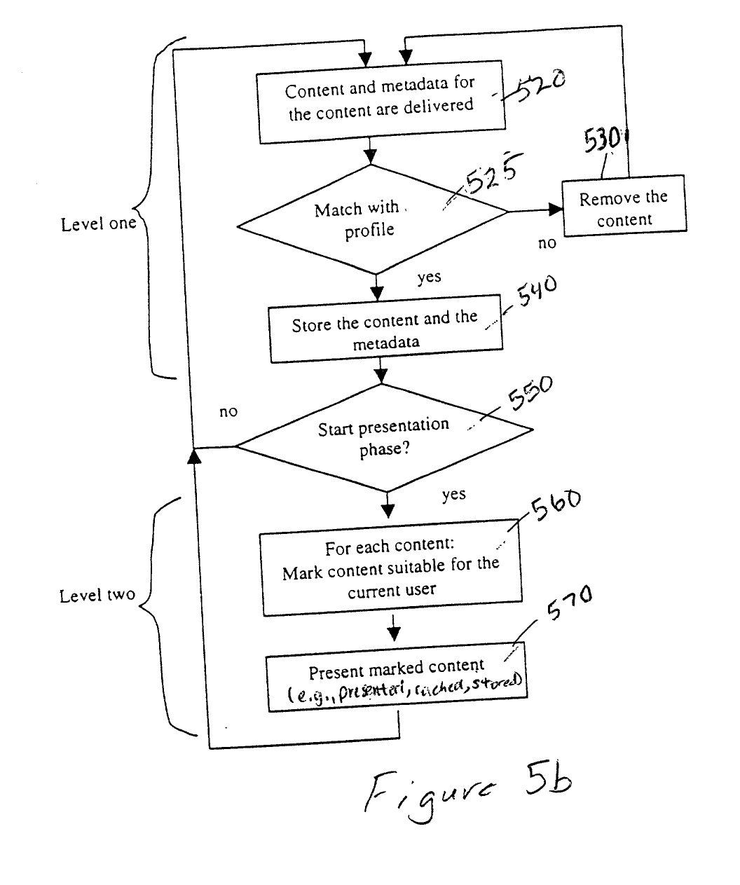

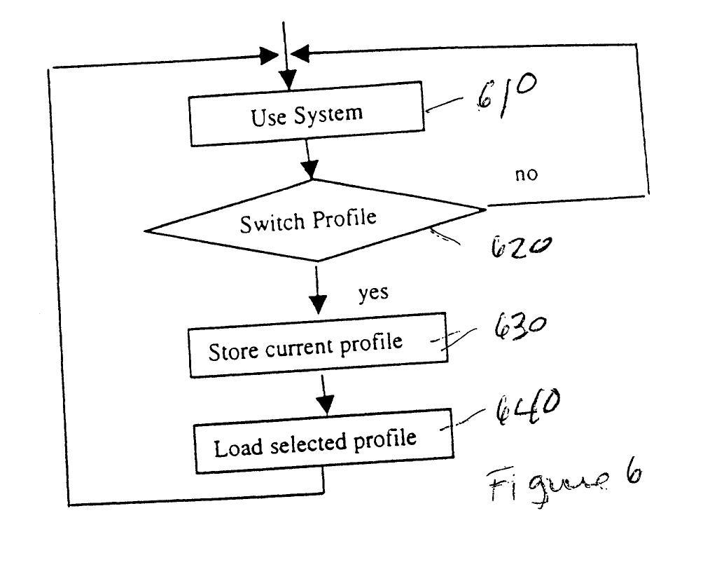

One embodiment is presented in FIG. 5a. Referring to FIG. 5a, the metadata is correlated or mapped to the corresponding content, step 505. At step 510, content having metadata that does not match the preference profile or preference profiles associated with the device is removed from the device. Thus incoming content may not be stored or stored content may be removed, thereby freeing up storage for other content. This first level of filtering may be performed with respect to one user profile, for example, the user currently using the device, or may be performed with respect to all user profiles associated with the device.

At step 515, the second level of filtering is performed. The content having metadata that matches preference of profiles of a user or users is stored or presented (e.g., displayed). In one embodiment, only content that matches the preference profile that is active for the current presentation session is considered presentation. Alternately, the presentation order may be adapted. For example, in one embodiment, programming content may be prioritized. Programming prioritized as “must show” overrides all content selections. In this embodiment, memory may be freed up for programming prioritized as “must show”. In another embodiment, programming content may be removed after being viewed a specified number of times, for example after content has been reviewed twice. Thus the programming eventually presented may be determined by programming content priority and programming content availability.

FIG. 5b shows one embodiment of a two level filtering process which may be used to filter programming content where there are multiple system users. At step 520, the provider delivers content, which is augmented by metadata. The metadata might arrive before, with or after the content. The programming content and metadata is mapped for subsequent referral and use.

At step 525 the system determines whether a preference profile matches any of the programming content. In one embodiment, content is examined at time of delivery. However, it is readily apparent that stored content may be examined and removed if the corresponding metadata does not match the applicable preference profiles. In one embodiment, this is achieved by comparing fields of the preference profile, e.g. subject: football, with corresponding fields of the metadata.

If no profiles are found to match content, the content is removed, step 530. If profiles are found to match the content, the content and metadata are stored, step 540.

The second phase is related to sending content to a user, e.g., the user currently viewing programming or using the device. At operation 550 it is determined whether or not the presentation phase should be started. In one embodiment, this is dependent upon whether there is a current user utilizing the device. In this embodiment, only the content that matches the user profile of an active user is considered for presentation. In alternate embodiments, additional context, related for example to default or general user profiles, may be included.

At step 560, the content that is suitable for the current user is marked. In one embodiment, at step 570 this content is presented, cached or stored for later presentation.

The preference profiles may also be used to manage multiple customizations on a single or group of devices. It is desirable to customize many services and media devices. However, when multiple users have access to the device or the service, and when these users have conflicting preferences, problems may arise as the services and devices operate in accordance with a single profile that is used by multiple users to manipulate the device or service.

In one embodiment, the device stores multiple user profiles. When a user uses the device, the device can be switched to operate in accordance with the user's preference profile. In one embodiment, when the user activates or “turns on” the device, a default preference profile, which may be a set profile or a general profile or alternately the last profile used, is used in the operation of the device. The user may at any time switch to another profile. The current profile is stored, typically in nonvolatile memory, and the selected profile is loaded to customize the device in accordance with the selected profile. The device thereafter operates in accordance with the selected profile.

The profiles may be system specific. For example, the profiles may be identified by user name, user type, code (e.g., User 1) or color. One or multiple users may have access to all or some of the profiles. The selection mechanism may be as simple as a button which when depressed moves from profile to profile, or more complex, such as a graphical user interface operating in conjunction with an input device. Furthermore, the profile selection process may include an authorization phase to prevent unauthorized users from accessing profiles.

One embodiment is illustrated in FIG. 6. At step 610, use of the device or system is detected. The device operates in accordance with a default profile that may be any preset profile, for example, a predetermined generic profile or the last profile used. The user may continue to use the device using the current profile or may switch profiles, step 620. In one embodiment, at step 630, the current profile is stored. This is to insure that the current settings and preferences with respect to that particular profile are maintained. At step 640, the selected profile is loaded and the device now operates in accordance with the selected profile.

It is contemplated that user preference profiles can be utilized for a variety of devices. For example, a user may maintain multiple preference profiles corresponding to different devices. Alternately, the user may maintain one user profile that may be used in the operation of a variety of types of devices and systems that are responsive to at least some of the information contained in the user profile. For example a user profile may indicate that the user likes to listen to rock music and view sports news. In one embodiment, an applicable profile is received through the world wide web and routed to the device(s) to provide the service(s). In an alternate embodiment, the user profile or profiles are stored on a removable media for easy transfer to other systems or devices having a port to accept the removable media. The device would then load the profile from the removable media and utilize the applicable preferences contained in the profile to operate the device, ignoring those preferences not applicable or not operable on the device. In a multi-profile environment, a selection mechanism would be included to select the desired profile.

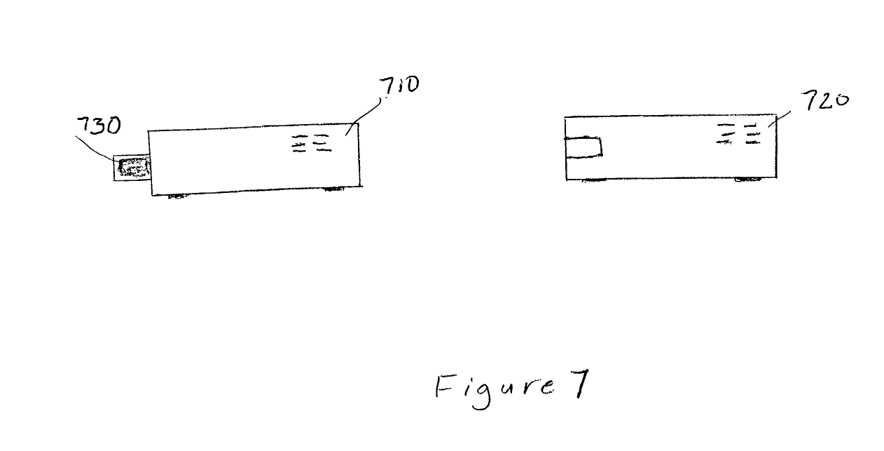

The advantages may be illustrated with respect to the embodiment illustrated in FIG. 7. A removable media 730 is coupled to a first device 710. One example of a removable media is the Memory Stick (MemoryStick is a trademark of Sony Corporation) removable media. If the media 730 has not been configured to contain the user profile, the profile is loaded onto the media 730. The media 730 may be subsequently detached from the device 710 and coupled to device 720. Device 720 loads the profile and operates in accordance with the profile.

In the foregoing specification, the invention has been described with reference to specific and exemplary embodiments thereof. It will however, be evident that various modifications and changes may be made thereto without departing from the broader spirit and scope of the invention as set forth in the appended claims. The specifications and drawings are, accordingly, to be regarded in an illustrative rather than a restrictive sense.

What is claimed is:

1. A method for personalizing user content comprising:
monitoring a user's pattern of behavior; and
characterizing a type of user based upon a frequency of a similar pattern of behavior monitored;
wherein a user's profile can be updated according to the type of user and the user's profile is used to personalize user content.

2. The method as set forth in claim 1, wherein the user's profile is used to filter content.

3. The method as set forth in claim 1, wherein the user's profile is used to update a preference profile, the preference profile used to filter content.

4. The method as set forth in claim 1, wherein user information content is selected from the group consisting of broadcasts, digitally stored content, media and interactive content.

5. The method as set forth in claim 1, wherein a user's pattern of behavior is selected from the group consisting of a pattern of viewing content and a pattern of accessing content.

6. The method as set forth in claim 1, wherein the user's pattern of behavior comprises a user's pattern of viewing program content and said monitoring comprises classifying the user as a type of user and determining a user profile in accordance with the type of the user and the content viewed.

7. The method as set forth in claim 1, wherein the user's pattern of behavior comprises a user's pattern of viewing program content and said monitoring comprises classifying the user as a type of user and determining user preferences in accordance with the type of the user and the content viewed.

8. The method as set forth in claim 1, wherein the type of user is selected from the group consisting of a content surfer and a longtime watcher.

9. The method as set forth in claim 1, wherein characterizing the user comprises recognizing at least one pattern of timing sequences of viewing program content and identifying similar viewing patterns a predefined number of times.

10. The method as set forth in claim 1, wherein if a user is classified as a content surfer, the user's profile is updated after viewing content for a first period of time, and if the user is classified as a longtime watcher, the user's profile is updated after viewing content for a second period of time, the second period longer than the first period.

11. The method as set forth in claim 1, further comprising filtering content comprising:
filtering at a first level to remove content that does not fit into the user's profile; and
filtering at a second level to select content corresponding to the user's profile.

12. The method as set forth in claim 11, wherein the user's profile comprises user preferences.

13. The method as set forth in claim 11, further comprising mapping metadata and content, wherein content that does not fit into the user's profile is identified by looking at mapped metadata.

14. The method as set forth in claim 1, further comprising managing a plurality of profiles, comprising:
storing at least a portion of a current profile, the at least a portion corresponding to a specified device;
identifying a selected profile; and
loading at least a portion of the selected profile corresponding to the specified device, wherein the specified device operates at least in part in accordance with the at least a portion of the selected profile

15. The method as set forth in claim 1, further comprising controlling a device using at least a portion of a profile comprising:
storing at least a portion of a current profile, the at least a portion corresponding to the device;
identifying a selected profile; and
loading at least a portion of the selected profile corresponding to the device wherein identifying is responsive to user input.

16. The method as set forth in claim 1, further comprising storing the user's profile on a removable media such that the media may be coupled to an alternate device, the alternate device responsive to the user's profile.

17. The method as set forth in claim 16, wherein the alternate device is responsive to the components of the profile within the alternate device's capabilities.

18. A method for filtering content comprising:
filtering at a first level to remove content that does not fit into the user's preferences; and
filtering at a second level to select content corresponding to the user's preferences, wherein the user's preferences identify content selected from the group consisting of content the user is interested in and content the user is not interested in.

19. The method as set forth in claim 18, further comprising mapping metadata and content, wherein filtering is performed using the mapped metadata to identify content.

20. The method as set forth in claim 18, wherein filtering at the second level corresponds to a current user's behavior profile session.

21. A method for managing multiple profiles on a device comprising:
storing at least a portion of a current profile, the at least a portion corresponding to the device;
identifying a selected profile; and
loading at least a portion of the selected profile corresponding to the device wherein the device operates at least in part in accordance with the at least a portion of the selected profile.

22. The method as set forth in claim 21, wherein identifying is responsive to user input.

23. A method for utilizing at least one profile of at least one user, the method comprising:
storing the at least one profile on a removable media;
coupling the removable media to a device; and
configuring operation of the device in accordance with device components of the at least one profile.

24. The method as set forth in claim 23, wherein the device components are a subset of all the components of the behavior profile.

25. The method as set forth in claim 24, wherein the device components are selected as those applicable to the device.

26. The method as set forth in claim 23, further comprising removing the media from the device and coupling the media to an alternate device, wherein the operation of the alternate device is configured in accordance with alternate device components of the at least one behavior profile.

27. The method as set forth in claim 26, wherein the device components are different from the alternate device components.

28. A computer readable medium comprising instructions, which when executed by a processing system, perform a method for personalizing user content comprising:
monitoring a user's pattern of behavior; and
characterizing a type of user based upon a frequency of a similar pattern of behavior monitored;
wherein a user's profile can be updated according to the type of user and the user's profile is used to personalize user content.

29. The computer readable medium as set forth in claim 28, wherein the user's profile is used to filter content.

30. The computer readable medium as set forth in claim 28, wherein the user's profile is used to update a preference profile, the preference profile used to filter content.

31. The computer readable medium as set forth in claim 28, wherein the user's pattern of behavior comprises a user's pattern of viewing program content and said monitoring comprises classifying the user as a type of user and determining a user preference profile in accordance with the type of the user and the content viewed.

32. The computer readable medium as set forth in claim 28, wherein the user's pattern of behavior comprises a user's pattern of viewing program content and said monitoring comprises classifying the user as a type of user and determining user preferences in accordance with the type of the user and the content viewed.

33. The computer readable medium as set forth in claim 28, wherein the type of user is selected from the group consisting of a content surfer and a longtime watcher.

34. The computer readable medium as set forth in claim 28, wherein characterizing the user comprises recognizing at least one pattern of timing sequences of viewing program content and identifying similar viewing patterns a predefined number of times.

35. The computer readable medium as set forth in claim 28, wherein if a user is classified as a content surfer, the user's behavior profile is updated after viewing content for a first period of time, and if the user is classified as a longtime watcher, the user's behavior profile is updated after viewing content for a second period of time, the second period longer than the first period.

36. The computer readable medium as set forth in claim 28, further comprising filtering content comprising:
filtering at a first level to remove content that does not fit into the user's profile; and
filtering at a second level to select content corresponding to the user's profile.

37. The computer readable medium as set forth in claim 36, wherein the user's profile comprises user preferences.

38. The computer readable medium as set forth in claim 36, further comprising mapping metadata and content, wherein content that does not fit into the user's behavior profile is identified by looking at mapped metadata.

39. The computer readable medium as set forth in claim 28, further comprising managing a plurality of profiles, comprising:
storing at least a portion of a current profile, the at least a portion corresponding to a specified device;
identifying a selected profile; and
loading at least a portion of the selected profile corresponding to the specified device, wherein the specified device operates at least in part in accordance with the at least a portion of the selected profile

40. The computer readable medium as set forth in claim 28, further comprising controlling a device using at least a portion of a profile comprising:
storing at least a portion of a current profile, the at least a portion corresponding to the device;
identifying a selected profile; and
loading at least a portion of the selected profile corresponding to the device wherein identifying is responsive to user input.

41. The computer readable medium as set forth in claim 28, further comprising storing the user's profile on a removable media such that the media may be coupled to an alternate device, the alternate device responsive to the user's behavior profile.

42. The computer readable medium as set forth in claim 41, wherein the alternate device is responsive to the components of the profile within the alternate device's capabilities.

43. A computer readable medium comprising instructions, which when executed by a processing system, perform a method for filtering content comprising:
filtering at a first level to remove content that does not fit into the user's preferences; and
filtering at a second level to select content corresponding to the user's preferences, wherein the user's preferences identify content selected from the group consisting of content the user is interested in and content the user is not interested in.

44. The computer readable medium as set forth in claim 43, further comprising mapping metadata and content, wherein filtering is performed using the mapped metadata to identify content.

45. The computer readable medium as set forth in claim 43, wherein filtering at the second level corresponding to a current user's behavior profile session.

46. A computer readable medium comprising instructions, which when executed by a processing system, perform a method for managing multiple profiles on a device comprising:
storing at least a portion of a current profile, the at least a portion corresponding to the device;
identifying a selected profile; and
loading at least a portion of the selected profile corresponding to the device wherein the device operates at least in part in accordance with the at least a portion of the selected profile.

47. The computer readable medium as set forth in claim 46, wherein identifying is responsive to user input.

48. A computer readable medium comprising instructions, which when executed by a processing system, perform a method for utilizing at least one profile of at least one user, the method comprising:
storing the at least one profile on a removable media;
coupling the removable media to a device; and
configuring operation of the device in accordance with device components of the at least one profile.

49. The computer readable medium as set forth in claim 48, wherein the device components are a subset of all the components of the behavior profile.

50. The computer readable medium as set forth in claim 48, wherein the device components are selected as those applicable to the device.

51. The computer readable medium as set forth in claim 48, further comprising removing the media from the device and coupling the media to an alternate device, wherein the operation of the alternate device is configured in accordance with alternate device components of the at least one behavior profile.

52. The computer readable medium as set forth in claim 51, wherein the device components are different from the alternate device components.

53. A system comprising a processor configured to personalize user information content by monitoring a user's pattern of behavior and characterizing a type of user based upon a frequency of a similar pattern of behavior monitored;
wherein a user's profile can be updated according to the type of user and the user's profile is used to personalized user information content.

54. The system as set forth in claim 53, further comprising a filter, wherein the user's profile is used to filter content.

55. The system as set forth in claim 53, further comprising a user preference profile, the user's profile used to update the user preference file, the user preference file used to used to filter content.

56. The system as set forth in claim 53, wherein the processor is further configured to filter content using the user's profile.

57. The system as set forth in claim 53, wherein the processor is further configured to update a preference profile, the preference profile used to filter content.

58. The system as set forth in claim 53, wherein a user's pattern of behavior is selected from the group consisting of a pattern of viewing content and a pattern of accessing content.

59. The system as set forth in claim 53, wherein the user's pattern of behavior comprises a user's pattern of viewing program content and said processor is configured to classify the user as a type of user and determine a user preference profile in accordance with the type of the user and the content viewed.

60. The system as set forth in claim 53, wherein the user's pattern of behavior comprises a user's pattern of viewing program content and said processor is configured to classify the user as a type of user and determine preferences in accordance with the type of the user and the content viewed.

61. The system as set forth in claim 53, wherein the type of user is selected from the group consisting of a content surfer and a longtime watcher.

62. The system as set forth in claim 53, wherein the processor characterizes the user by recognizing at least one pattern of timing sequences of viewing program content and identifying similar viewing patterns a predefined number of times.

63. The system as set forth in claim 53, wherein if a user is classified as a content surfer, the user's profile is updated after viewing content for a first period of time, and if the user is classified as a longtime watcher, the user's profile is updated after viewing content for a second period of time, the second period longer than the first period.

64. The system as set forth in claim 53, wherein the processor is further configured to filter content by filtering to remove content that does not fit into the user's profile and filtering to select content corresponding to the user's profile.

65. The system as set forth in claim 64, wherein the process is further configured to map metadata and content, wherein content that does not fit into the user's profile is identified by looking at mapped metadata.

66. The system as set forth in claim 53, further comprising a profile management module to manage a plurality of profiles, the profile management module configured to store at least a portion of a current profile, the at least a portion corresponding to a specified device coupled to the profile management module and load at least a portion of a selected profile corresponding to the specified device, wherein the specified device operates at least in part in accordance with the at least a portion of the selected profile.

67. The system as set forth in claim 66, wherein processor comprises the profile management module.

68. The system as set forth in claim 66, wherein the processor is coupled to the processor.

69. The system as set forth in claim 53, further comprising a device controller configured to control a device using at least a portion of a profile the device controller configured to store at least a portion of a current profile, the at least a portion corresponding to the device and load at least a portion of a selected profile corresponding to the device wherein the selected profile is identified in responsive to user input.

70. The system as set forth in claim 69, wherein the processor comprises the device controller.

71. The system as set forth in claim 66, wherein the device controller is coupled to the processor.

72. The system as set forth in claim 53, further comprising removable media removably coupled to the processor and configured to store the user's behavior profile such that the media may be removed from being coupled to the processor and coupled to an alternate device, the alternate device responsive to the user's behavior profile.

73. The system as set forth in claim 72, wherein the alternate device is responsive to the components of the profile within the alternate device's capabilities.

74. The system as set forth in claim 53, wherein the processor is part of a system selected from the group consisting of a service provider, a set top box, a computer system, a broadcast receiver and a data receiving device.

75. A multiple level filter for filtering content comprising:
a first level filter configured to remove content that does not fit into a user's preferences; and
a second level filter configured to select content corresponding to the user's preferences, wherein the user's profile identifies content selected from the group consisting of content the user is interested in and content the user is not interested in.

76. The filter as set forth in claim 75, further comprising a map module configured to map metadata and content, wherein filtering is performed using the mapped metadata to identify content.

77. The filter as set forth in claim 75, wherein filtering at the second level corresponds to a current user's preferences session.

78. The filter as set forth in claim 75, wherein the filter accesses profiles of a plurality of users and the first level filter is configured to remove content that does not fit into the plurality of user profiles.

79. The filter as set forth in claim 75, wherein the filter is part of a system selected from the group consisting of a service provider, a set top box, a computer system, a broadcast receiver and a data receiving device.

80. The filter as set forth in claim 75, further comprising storage media, wherein the first level filter deletes content from the storage media.

81. A device comprising:
an operating module configured to control operation of the device responsive to a current user profile;
an input configured to receive a selection of an alternate profile;
a storage media configured to store the current profile in response to the selection of an alternate profile;
a loader configured to load the alternate profile wherein the device operates at least in part in accordance with the alternate profile.

82. The device as set forth in claim 81, wherein the input accepts user input.

83. The device as set forth in claim 81, wherein the input comprises a plurality of buttons selectable by the user.

84. The device as set forth in claim 81, wherein the device is selected from the group consisting of consumer electronics devices, devices that access interactive services, broadcast receivers, set top boxes and media devices.

85. A removable media configured to store at least one user profile wherein when coupled to a device, the operation of the device corresponds with device components of the at least one user profile.

86. The removable media as set forth in claim 85, wherein the device components are a subset of all the components of the user profile.

87. The removable media as set forth in claim 86, wherein the device components selected are those applicable to the device.

88. The removable media as set forth in claim 85, wherein when the media is removed from a first device and coupled to a second device, the operation of the second device is configured in accordance with second device components of the at least one user profile.

89. The removable media as set forth in claim 88, wherein the first device components are different from the second device components.

90. A device comprising:
a media port configured to couple a removable media, the removable media configured to store at least one profile;
a controller coupled to the media port and configured to received a profile and operate the device in accordance with the profile.

91. The device as set forth in claim 90, wherein the device is operated in accordance with the profile and the device's capabilities, such that if the profile specifies a capability not found in the device, the specified capability is ignored.

92. The device as set forth in claim 90, wherein the device is part of a system selected from the group consisting of a set top box, a computer system, a broadcast receiver and a data receiving device.
